(19) United States
(12) Patent Application Publication
(10) Pub. No.: US 2011/0041083 A1
(43) Pub. Date: Feb. 17, 2011

(54) SYSTEM AND METHODOLOGY FOR PROVIDING SHARED INTERNET EXPERIENCE

(76) Inventors: Oz Gabai, Tel Aviv (IL); Nimrod Sandlerman, Ramat Gan (IL)

Correspondence Address: LADAS & PARRY LLP, 224 SOUTH MICHIGAN AVENUE, SUITE 1600, CHICAGO, IL, 60604, US

(21) Appl. No.: 12/746,986

(22) PCT Filed: Dec. 26, 2007
(86) PCT No.: PCT/IL07/01610

§ 371 Date: Nov. 2, 2010

Related U.S. Application Data
(60) Provisional application No. 61/012,925, filed on Dec. 12, 2007.
(60) Provisional application No. 61/016,588, filed on Dec. 25, 2007.
(60) Provisional application No. 61/016,589, filed on Dec. 25, 2007.

(51) Int. Cl. G06F 3/01; G06F 15/16

(52) U.S. Cl. 715/753

(57) ABSTRACT

A method for mutually interactive Internet activities including connecting a plurality of user clients, which together represent a group, to at least one Internet activity server, supplying to each of the plurality of user clients representing the group at least partially identical content from the at least one Internet activity server, whereby each of the plurality of users in the group has at least partially common shared Internet activity experience and based on information regarding at least one of the users in the group, which information indicates at least one common characteristic of the plurality of users in the group, configuring the at least partially common shared Internet activity experience responsive to the at least one common characteristic.

### REFERENCE TO RELATED APPLICATIONS

Reference is made to U.S. Provisional Patent Application Ser. No. 61/012,925, filed Dec. 12, 2007 and entitled “AN ONLINE EDUCATION COLLABORATION SYSTEM”, U.S. Provisional Patent Application Ser. No. 61/016,588, filed Dec. 25, 2007 and entitled “AN ANNOUNCEMENT INSERTION SYSTEM FOR ONLINE VIDEO SPECTATORS” and U.S. Provisional Patent Application Ser. No. 61/016,589, filed Dec. 25, 2007 and entitled “AN EQUATION SEARCH ENGINE,” the disclosures of which are hereby incorporated by reference and priority of which are hereby claimed pursuant to 37 CFR 1.78(a) (4) and (5)(i).

### FIELD OF THE INVENTION

The present invention relates to networked computer systems and methodologies for providing shared user experiences.

### BACKGROUND OF THE INVENTION

The following U.S. patent publications and other publications are believed to represent the current state of the art:

U.S. Pat. Nos. 7,149,665 and 6,901,379;

U.S. Published Patent Application Nos. 20070276721, 20070220540, 20060173702, 20050108033, 20050096997 and 20050033656; and

Supporting Sociability in a Shared Browser, Farnham, Shelly, et al. available online at http://research.microsoft.com/scg/papers/sharedbrowsinginteract.pdf.

### SUMMARY OF THE INVENTION

The present invention seeks to provide improved networked computer systems and methodologies for providing groupized shared user experiences.

As used throughout the specification and claims, the term “groupize” means “customize in accordance with characteristics of a specific group of specific individuals having a shared Internet user experience”. Thus, for example a groupized shared user experience is an experience which is customized based, inter alia, on the characteristics, such as the ages and nationalities, of the individual members of a group shopping together on the Internet. A groupized shared user experience is not, however, a shared user experience which is customized based entirely on anonymous statistical characteristics of a larger population, such as for example selecting a language of presentation based on the country in which the individual members of the group reside.

There is thus provided in accordance with a preferred embodiment of the present invention a method for mutually interactive Internet activities including connecting a plurality of user clients, which together represent a group, to at least one Internet activity server, supplying to each of the plurality of user clients representing the group at least partially identical content from the at least one Internet activity server, whereby each of the plurality of users in the group has at least partially common shared Internet activity experience and based on information regarding at least one of the users in the group, which information indicates at least one common characteristic of the plurality of users in the group, configuring the at least partially common shared Internet activity experience responsive to the at least one common characteristic.

Preferably, the method for mutually interactive Internet activities also includes sensing the existence of communications between the plurality of users and in response to a group actuation input from at least one of the plurality of users, defining the group including the plurality of users based upon the sensing of the existence of communications. Additionally or alternatively, the method for mutually interactive Internet activities also includes enabling at least some of the plurality of users in the group to communicate during the at least partially common shared Internet activity experience.

Preferably, the method for mutually interactive Internet activities also includes synchronizing the display of the at least partially common shared Internet activity experience on the plurality of user clients in the group. Additionally or alternatively, the information regarding at least one of the users is updated based on user activity during the at least partially common shared Internet activity experience and the updated information is employed in reconfiguring at least part of the at least partially common shared Internet activity experience. Alternatively or additionally, the configuring the at least partially common shared Internet activity experience responsive to the at least one common characteristic includes at least one of selecting a shopping site, selecting a product, selecting a pathway through a shopping site, selecting speed of passage through a shopping site, selecting specific group-based advertising and selecting a specific group-based offer.

Preferably, the method for mutually interactive Internet activities also includes automatically creating the group based on communication between members of the group via at least one of voice communication over a cellular network, voice communication over a computer network, text communication over a cellular network, text communication over a computer network and collaboration over a computer network. Additionally or alternatively, the information regarding at least one of the users in the group is obtained from communication among at least some of the users in the group via at least one of voice communication over a cellular network, voice communication over a computer network, text communication over a cellular network, text communication over a computer network and collaboration over a computer network.

There is also provided in accordance with another preferred embodiment of the present invention a method for creating virtual groups of persons in an Internet environment including sensing the existence of communications between at least two persons, in response to a group actuation input from at least one of the at least two persons, defining a virtual group including the at least two persons based upon the sensing of the existence of communications and communicating information regarding the virtual group to an Internet activity server for enabling the Internet activity server to provide at least partially common shared Internet activity experience to members of the virtual group.

Preferably, the information regarding the virtual group includes at least one characteristic characterizing the virtual group. Additionally or alternatively, the information includes identification of members of the virtual group. Alternatively or additionally, the information includes Internet addressing information of members of the virtual group.

Preferably, the method for creating virtual groups of persons also includes enabling at least some of the at least two persons in the group to communicate during the at least partially common shared Internet activity experience.

Preferably, the method for creating virtual groups of persons also includes synchronizing the display of the at least partially common shared Internet activity experience to the at least two persons in the group. Additionally or alternatively, the information regarding at least one of the persons is updated based on activity during the at least partially common shared Internet activity experience and the updated information is employed in reconfiguring at least part of the at least partially common shared Internet activity experience.

Preferably, the at least partially common shared experience responsive to the at least one common characteristic is provided by at least one of selecting a shopping site, selecting a product, selecting a pathway through a shopping site, selecting speed of passage through a shopping site, selecting specific group-based advertising and selecting a specific group-based offer. Additionally or alternatively, the method also includes automatically creating the group based on communication between members of the group via at least one of voice communication over a cellular network, voice communication over a computer network, text communication over a cellular network, text communication over a computer network and collaboration over a computer network. Alternatively or additionally, the information regarding at least one of the users in the group is obtained from communication among at least some of the users in the group via at least one of voice communication over a cellular network, voice communication over a computer network, text communication over a cellular network, text communication over a computer network and collaboration over a computer network.

There is further provided in accordance with yet another preferred embodiment of the present invention a method for creating virtual groups of persons in an Internet environment including receiving information regarding a virtual group at an Internet activity server for enabling the Internet activity server to provide at least partially common shared Internet activity experience to members of the virtual group, wherein the information regarding the virtual group includes at least one characteristic characterizing the virtual group.

Preferably, the information includes identification of members of the virtual group. Additionally or alternatively, the information includes Internet addressing information of members of the virtual group.

Preferably, the method for creating virtual groups of persons also includes enabling at least some of the persons in the group to communicate during the at least partially common shared Internet activity experience. Additionally or alternatively, the method for creating virtual groups of persons also includes synchronizing the display of the at least partially common shared Internet activity experience on the members of the virtual group.

Preferably, the information regarding at least one of the persons is updated based on user activity during the at least partially common shared Internet activity experience and the updated information is employed in reconfiguring at least part of the at least partially common shared Internet activity experience. Additionally or alternatively, the at least partially common shared experience responsive to the at least one common, characteristic is provided by at least one of selecting a shopping site, selecting a product, selecting a pathway through a shopping site, selecting speed of passage through a shopping site, selecting specific group-based advertising and selecting a specific group-based offer.

Preferably, the method for creating virtual groups also includes automatically creating the group based on communication between members of the group via at least one of voice communication over a cellular network, voice communication over a computer network, text communication over a cellular network, text communication over a computer network and collaboration over a computer network. Additionally or alternatively, the information regarding at least one of the users in the group is obtained from communication among at least some of the users in the group via at least one of voice communication over a cellular network, voice communication over a computer network, text communication over a cellular network, text communication over a computer network and collaboration over a computer network.

There is yet further provided in accordance with still another preferred embodiment of the present invention a method for interactive Internet activities including connecting a plurality of user clients, which together represent a group of users, to at least one Internet activity server and supplying to at least one of the plurality of user clients representing the group, content from the at least one Internet activity server based at least in part on Internet activity experience of at least another one of the group of users.

Preferably, the content includes a commercial offer. Additionally or alternatively, the method for interactive Internet activities also includes based on the content, configuring an at least partially common shared Internet activity experience for the group of users and enabling at least some of the users in the group to communicate during the at least partially common shared Internet activity experience. Additionally, the method for mutually interactive Internet activities also includes synchronizing the display of the at least partially common shared Internet activity experience to the group of users.

Preferably, the information regarding at least one of the users is updated based on user activity during the at least partially common shared Internet activity experience and the updated information is employed in reconfiguring at least part of the at least partially common shared Internet activity experience. Additionally or alternatively, the at least partially common shared experience responsive to the at least one common characteristic is provided by at least one of selecting a shopping site, selecting a product, selecting a pathway through a shopping site, selecting speed of passage through a shopping site, selecting specific group-based advertising and selecting a specific group-based offer.

Preferably, the method also includes automatically creating the group based on communication between members of the group via at least one of voice communication over a cellular network, voice communication over a computer network, text communication over a cellular network, text communication over a computer network and collaboration over a computer network. Additionally or alternatively, the information regarding at least one of the users in the group is obtained from communication among at least some of the users in the group via at least one of voice communication over a cellular network, voice communication over a computer network, text communication over a cellular network, text communication over a computer network and collaboration over a computer network.

There is still further provided in accordance with even a further preferred embodiment of the present invention a method for interactive Internet activities including connecting a plurality of user clients, which together represent a group of users, to at least one Internet activity server and supplying to at least one of the plurality of user clients representing the group, content from the at least one Internet activity server based at least in part on Internet activity experience of a person known to be associated with at least one of the group of users.

Preferably, the content includes a commercial offer. Additionally or alternatively, the method for interactive Internet activities according also includes based on the content, configuring an at least partially common shared Internet activity experience for the group of users and enabling at least some of the users in the group to communicate during the at least partially common shared Internet activity experience. Additionally, the method for mutually interactive Internet activities also includes synchronizing the display of the at least partially common shared Internet activity experience to the group of users.

Preferably, the information regarding at least one of the users is updated based on user activity during the at least partially common shared Internet activity experience and the updated information is employed in reconfiguring at least part of the at least partially common shared Internet activity experience. Additionally or alternatively, the at least partially common shared experience responsive to, the at least one common characteristic is provided by at least one of selecting a shopping site, selecting a product, selecting a pathway through a shopping site, selecting speed of passage through a shopping site, selecting specific group-based advertising and selecting a specific group-based offer.

Preferably, the method for mutually interactive Internet activities also includes automatically creating the group based on communication between members of the group via at least one of voice communication over a cellular network, voice communication over a computer network, text communication over a cellular network, text communication over a computer network and collaboration over a computer network. Additionally or alternatively, the information regarding at least one of the users in the group is obtained from communication among at least some of the users in the group via at least one of voice communication over a cellular network, voice communication over a computer network, text communication over a cellular network, text communication over a computer network and collaboration over a computer network.

There is also provided in accordance with another preferred embodiment of the present invention a system for providing mutually interactive Internet activities including a shared interest analyzer operative, based on information regarding at least one of a plurality of users in a group, which information indicates at least one common characteristic of the plurality of users in the group, defining at least one shared interest of the plurality of users in the group and a shared experience manager, supplying to each of a plurality of user clients representing the group, at least partially identical content from at least one Internet activity server, whereby each of a plurality of users in the group has at least partially common shared Internet activity experience, based at least partially on the at least one shared interest.

Preferably, the system for mutually interactive Internet activities also includes a group creation manager operative to define the group including the plurality of users and represented by the plurality of user clients. Additionally or alternatively, the group creation manager is operative to sense the existence of communications between the plurality of users and in response to a group actuation input from at least one of the plurality of users to define the group including the plurality of users based upon the sensing of the existence of communications.

Preferably, the system for mutually interactive Internet activities also includes a user communication module operative to enable at least some of the users in the group to communicate during the at least partially common shared Internet activity experience. Additionally or alternatively, the system for mutually interactive Internet also includes a synchronization controller operative to synchronize the display of the at least partially common shared Internet activity experience on the plurality of user clients in the group.

Preferably, the information regarding at least one of the users is updated based on user activity during the at least partially common shared Internet activity experience and the updated information is employed in reconfiguring at least part of the at least partially common shared Internet activity experience. Additionally or alternatively, the shared experience manager is operative to configure the at least partially common shared Internet activity experience responsive to the at least one common characteristic by selecting a shopping site, selecting a product, selecting a pathway through a shopping site, selecting speed of passage through a shopping site, selecting specific group-based advertising and selecting a specific group-based offer.

Preferably, the group is automatically created on communication between members of the group via at least one of voice communication over a cellular network, voice communication over a computer network, text communication over a cellular network, text communication over a computer network and collaboration over a computer network. Additionally or alternatively, the information regarding at least one of the users in the group is obtained from communication among at least some of the users in the group via at least one of voice communication over a cellular network, voice communication over a computer network, text communication over a cellular network, text communication over a computer network and collaboration over a computer network.

There is further provided in accordance with still another preferred embodiment of present invention a system for creating virtual groups of persons in an Internet environment including a communications sensor operative to sense the existence of communications between at least two persons, a virtual group definer operative in response to a group actuation input from at least one of the at least two persons to define a virtual group including the at least two persons based upon the sensing of the existence of communications and a communicator operative to communicate information regarding the virtual group to an Internet activity server for enabling the Internet activity server to provide at least partially common shared Internet activity experience to members of the virtual group.

Preferably, the information regarding the virtual group includes at least one characteristic characterizing the virtual group. Additionally or alternatively, the information includes identification of members of the virtual group.

Preferably, the system for creating virtual groups of persons also includes a user communication module operative to enable at least some of the persons in the group to communicate during the at least partially common shared Internet activity experience. Alternatively or additionally, the information includes Internet addressing information of members of the virtual group.

Preferably, the system for creating virtual groups also includes a synchronization controller operative to synchronize the display of the at least partially common shared Internet activity experience to members of the virtual group. Alternatively or additionally, the information regarding at least one of the users is updated based on user activity during the at least partially common shared Internet activity experience and the updated information is employed in reconfiguring at least part of the at least partially common shared Internet activity experience. Additionally or alternatively, the system for creating virtual groups also includes a shared experience manager operative to configure the at least partially common shared Internet activity experience responsive to the at least one common characteristic by selecting a shopping site, selecting a product, selecting a pathway through a shopping site, selecting speed of passage through a shopping site, selecting specific group-based advertising and selecting a specific group-based offer.

Preferably, the group is automatically created on communication between members of the group via at least one of voice communication over a cellular network, voice communication over a computer network, text communication over a cellular network, text communication over a computer network and collaboration over a computer network. Additionally or alternatively, the information regarding at least one of the users in the group is obtained from communication among at least some of the users in the group via at least one of voice communication over a cellular network, voice communication over a computer network, text communication over a cellular network, text communication over a computer network and collaboration over a computer network.

There is yet further provided in accordance with yet another preferred embodiment of the present invention a system for creating virtual groups of persons in an Internet environment including a group creation manager operative to define a virtual group including a plurality of users and represented by a plurality of user clients and an Internet activity server receiving information regarding the virtual group for providing an at least partially common shared Internet activity experience to members of the virtual group, wherein the information regarding the virtual group includes at least one characteristic characterizing the virtual group.

Preferably, the information includes identification of members of the virtual group. Alternatively or additionally, the information includes Internet addressing information of members of the virtual group.

Preferably, the system for creating virtual groups of persons also includes a user communication module operative to enable at least some of the users in the group to communicate during the at least partially common shared Internet activity experience. Additionally or alternatively, the system for creating virtual groups also includes a synchronization controller operative to synchronize the display of the at least partially common shared Internet activity experience on the plurality of user clients in the group.

Preferably, the information regarding at least one of the users is updated based on user activity during the at least partially common shared Internet activity experience and the updated information is employed in reconfiguring at least part of the at least partially common shared Internet activity experience. Alternatively or additionally, the system for creating virtual groups also includes a shared experience manager operative to configure the at least partially common shared Internet activity experience responsive to the at least one common characteristic by selecting a shopping site, selecting a product, selecting a pathway through a shopping site, selecting speed of passage through a shopping site, selecting specific group-based advertising and selecting a specific group-based offer.

Preferably, the group is automatically created on communication between members of the group via at least one of voice communication over a cellular network, voice communication over a computer network, text communication over a cellular network, text communication over a computer network and collaboration over a computer network. Additionally or alternatively, the information regarding at least one of the users in the group is obtained from communication among at least some of the users in the group via at least one of voice communication over a cellular network, voice communication over a computer network, text communication over a cellular network, text communication over a computer network and collaboration over a computer network.

There is even further provided in accordance with still another preferred embodiment of the present invention a system for providing interactive Internet activities including a group creation manager operative to define a virtual group including a plurality of users and represented by a plurality of user clients and a shared experience manager operative to supply to at least one of the plurality of user clients representing one of the group of users, content from at least one Internet activity server based at least in part on Internet activity experience of at least another one of the group of users.

Preferably, the content includes a commercial offer. Alternatively or additionally, the system for providing interactive Internet activities also includes a user communication module operative to enable at least some of the users in the group to communicate during the at least partially common shared Internet activity experience.

Preferably, the system for creating virtual groups also includes a synchronization controller operative to synchronize the display of the at least partially common shared Internet activity experience on the plurality of user clients in the group. Additionally or alternatively, the information regarding at least one of the users is updated based on user activity during the at least partially common shared Internet activity experience and the updated information is employed in reconfiguring at least part of the at least partially common shared Internet activity experience.

Preferably, the system for creating virtual groups also includes a shared experience manager operative to configure the at least partially common shared Internet activity experience responsive to the at least one common characteristic by selecting a shopping site, selecting a product, selecting a pathway through a shopping site, selecting speed of passage through a shopping site, selecting specific group-based advertising and selecting a specific group-based offer.

Preferably, the group is automatically created on communication between members of the group via at least one of voice communication over a cellular network, voice communication over a computer network, text communication over a cellular network, text communication over a computer network and collaboration over a computer network. Additionally or alternatively, the information regarding at least one of the users in the group is obtained from communication among at least some of the users in the group via at least one of voice communication over a cellular network, voice communication over a computer network, text communication over a cellular network, text communication over a computer network and collaboration over a computer network.

There is further provided in accordance with still another preferred embodiment of the present invention a system for providing interactive Internet activities including a group creation manager operative to define a virtual group including a plurality of users and represented by a plurality of user clients and a shared experience manager operative to supply to at least one of the plurality of user clients representing one of the group of users, content from at least one Internet activity server based at least in part on Internet activity experience of a person known to be associated with at least one of the group of users.

Preferably, the content includes a commercial offer.

Preferably, the system for providing interactive Internet activities also includes a user communication module operative to enable at least some of the users in the group to communicate during the at least partially common shared Internet activity experience. Additionally or alternatively, the system for creating virtual groups also includes a synchronization controller operative to synchronize the display of the at least partially common shared Internet activity experience on the plurality of user clients in the group.

Preferably, the information regarding at least one of the users is updated based on user activity during the at least partially common shared Internet activity experience and the updated information is employed in reconfiguring at least part of the at least partially common shared Internet activity experience. Additionally or alternatively, the system for creating virtual groups also includes a shared experience manager operative to configure the at least partially common shared Internet activity experience responsive to the at least one common characteristic by selecting a shopping site, selecting a product, selecting a pathway through a shopping site, selecting speed of passage through a shopping site, selecting specific group-based advertising and selecting a specific group-based offer.

Preferably, the group is automatically created on communication between members of the group via at least one of voice communication over a cellular network, voice communication over a computer network, text communication over a cellular network, text communication over a computer network and collaboration over a computer network. Alternatively or additionally, the information regarding at least one of the users in the group is obtained from communication among at least some of the users in the group via at least one of voice communication over a cellular network, voice communication over a computer network, text communication over a cellular network, text communication over a computer network and collaboration over a computer network.

### BRIEF DESCRIPTION OF THE DRAWINGS

The present invention will be understood and appreciated more fully from the following detailed description, taken in conjunction with the drawings in which:

FIG. 1 is a simplified pictorial illustration of operation of a system and functionality for providing a groupized Internet group experience in accordance with a preferred embodiment of the present invention;

FIGS. 2A, 2B, 2C, 2D, 2E and 2F are simplified illustrations of examples of various types of groupized Internet group experiences provided in accordance with a preferred embodiment of the present invention;

FIG. 3 is a simplified block diagram illustration of a system and functionality for providing a groupized Internet group experience in accordance with a preferred embodiment of the present invention which provides, inter alia, functionalities, examples of which appear in FIGS. 1-2F;

FIGS. 4A, 4B, 4C, 4D, 4E and 4F are simplified illustrations of six alternative configurations of the system architecture of FIG. 3;

FIG. 5A is a simplified illustration of a personal data structure administered by a group information manager, forming part of the structure illustrated in FIG. 3;

FIG. 5B is a simplified illustration of a group data structure administered by a group information manager, forming part of the structure illustrated in FIG. 3;

FIG. 6 is a simplified flow chart of functionality of shared interest analyzer, forming part of the structure illustrated in FIG. 3;

FIG. 7 is a simplified illustration of a typical shared interest matrix; and

FIG. 8 is a simplified illustration of the functionality of the shared experience manager, forming part of the structure illustrated in FIG. 3.

### DETAILED DESCRIPTION OF PREFERRED EMBODIMENTS

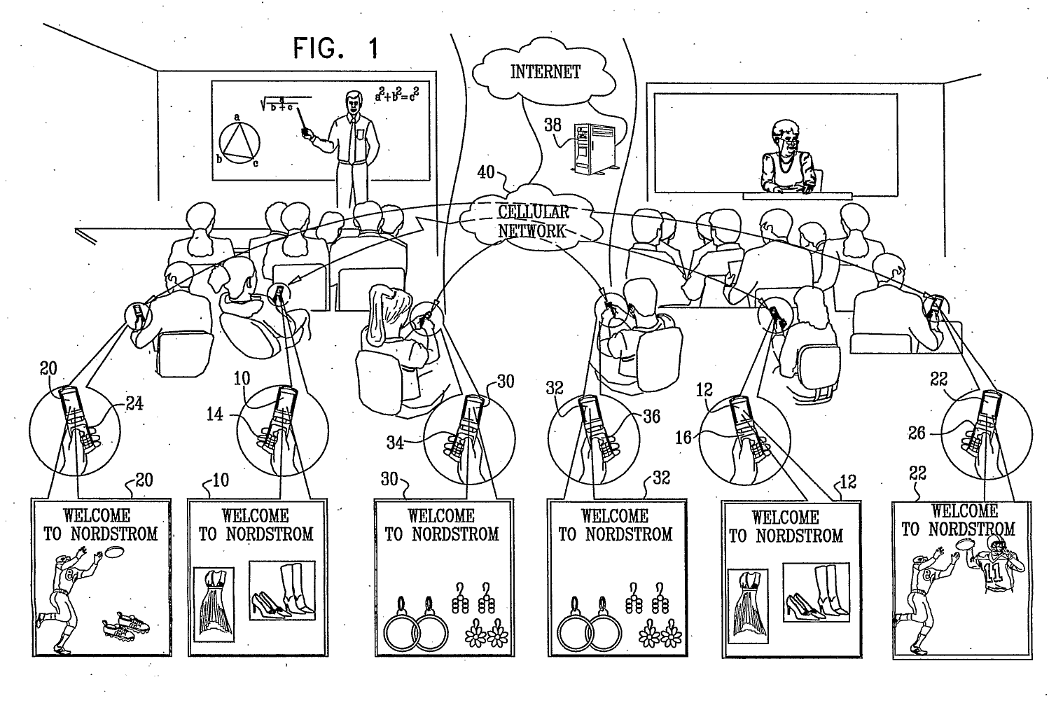

Reference is now made to FIG. 1, which is a highly simplified pictorial illustration of a system and functionality for providing a groupized shopping experience in accordance with a preferred embodiment of the present invention. As noted above, the term “groupized” means “customized in accordance with characteristics of a specific group of specific individuals having a shared Internet user experience”.

FIG. 1 illustrates three different groups of users, one being two teenage girls, the second being two teenage boys, and the third being a boyfriend and girlfriend, all engaged in Internet shopping during classes. All three groups are shopping at Nordstrom. In accordance with the present invention, the web functionality providing the Internet shopping experience for both groups is responsive to the characteristics of each of the specific groups of specific individuals to groupize each group's experience.

This is illustrated in FIG. 1 in that screens 10 and 12 of the user clients, here cellphones 14 and 16 of the teenage girls shopping together, automatically initially present to them clothing suitable for their age and gender, while screens 20 and 22 of the user clients, here cellphones 24 and 26 of the teenage boys shopping together, automatically initially present to them sports equipment suitable for their age and gender. Screens 30 and 32 of the user clients, here cellphones 34 and 36 of the boyfriend and girlfriend shopping together, automatically initially present to them a product suitable for their age and relationship, earrings to be bought by the boy for the girl for her birthday.

The system of the present invention employs one or more suitable programmed servers 38, connected to the Internet. The user client cellphones 14, 16, 24, 26, 34 and 36 typically connect to the Internet via a cellular network 40.

It may thus be appreciated from a consideration of FIG. 1 that the present invention provides a method for mutually interactive Internet activities including connecting a plurality of user clients, such as cellphones 14 and 16, or cellphones 24 and 26 or cellphones 34 and 36, which together represent a group, to a common Internet activity server, such as server 38, supplying to each of the plurality of user clients representing the group at least partially identical content from the common Internet activity server 38, whereby each of the plurality of users in the group have at least partially common shared Internet activity experience and based on information regarding each of the users in the group, which information indicates at least one common characteristic of the plurality of users in the group, configuring at least part of the common shared Internet activity experience responsive to the at least one common characteristic.

In the illustrative embodiment of FIG. 1, the group represented by cellphones 14 and 16 of the teenage girls shopping together receives on their respective screens 10 and 12 shopping displays that are at least partially identical. In FIG. 1, the welcome displays are identical and are customized to the group, identifying them by name, acknowledging the number of persons in the group with a discount tailored to that number and initially showing products which are believed to be most suitable for their common characteristics, here age and gender.

The group represented by cellphones 24 and 26 of the teenage boys shopping together receives on their respective screens 20 and 22 shopping displays that are at least partially identical. In FIG. 1, the welcome displays are identical and are customized to the group, identifying them by name, acknowledging the number of persons in the group with a discount tailored to that number and initially showing products which are believed to be most suitable for their common characteristics, here age and gender.

The group represented by cellphones 34 and 36 of the boyfriend and girlfriend shopping together receives on their respective screens 30 and 32 shopping displays that are at least partially identical. In FIG. 1, the welcome displays are identical and are customized to the group, identifying them by name, acknowledging the number of persons in the group and initially showing products which are believed to be most suitable for their common interests based on their individual characteristics, here age and gender and relationship.

The information regarding individual and group characteristics of the members of a group may be known from multiple available sources, such as for example, profiles provided by the members of the group, cell phone and instant messaging histories, shopping histories, Internet browsing histories and Internet collaborative activity histories.

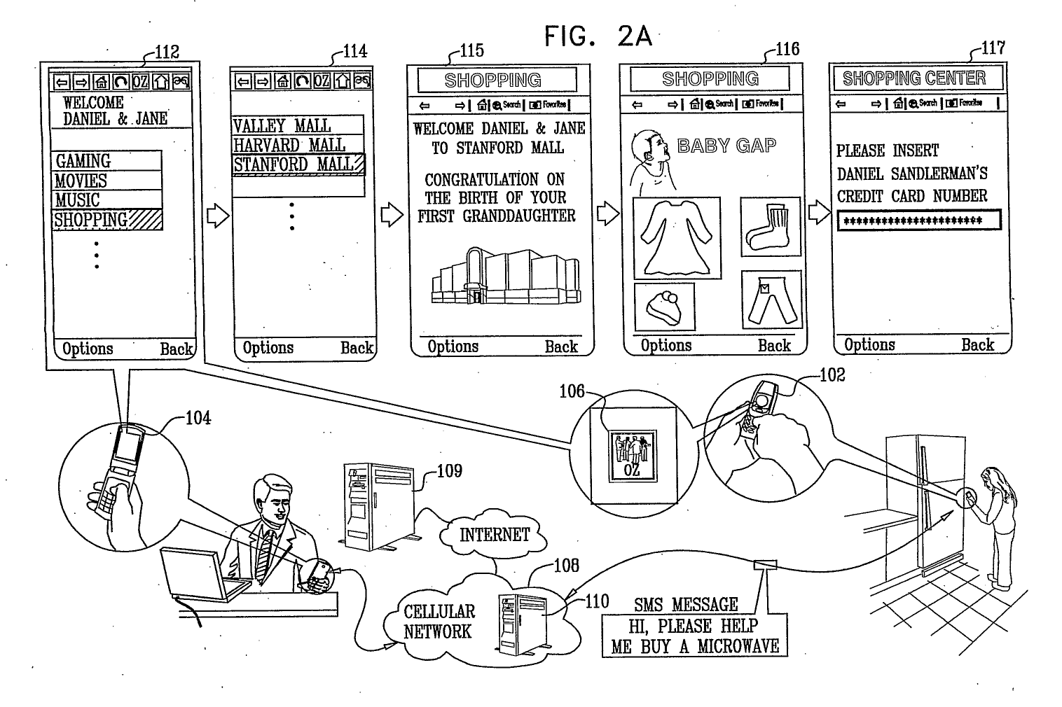

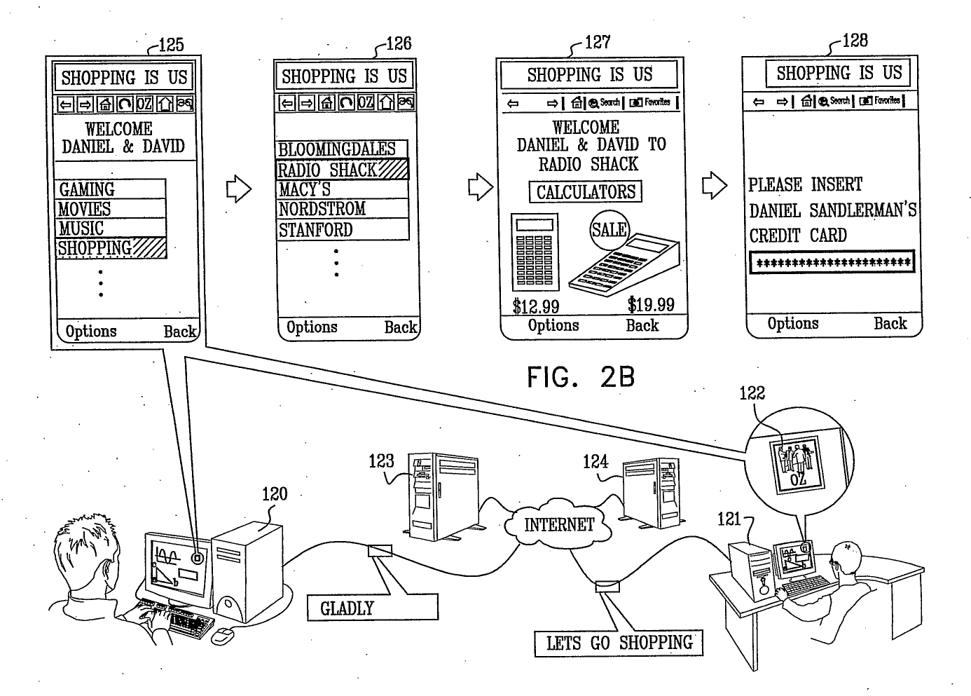

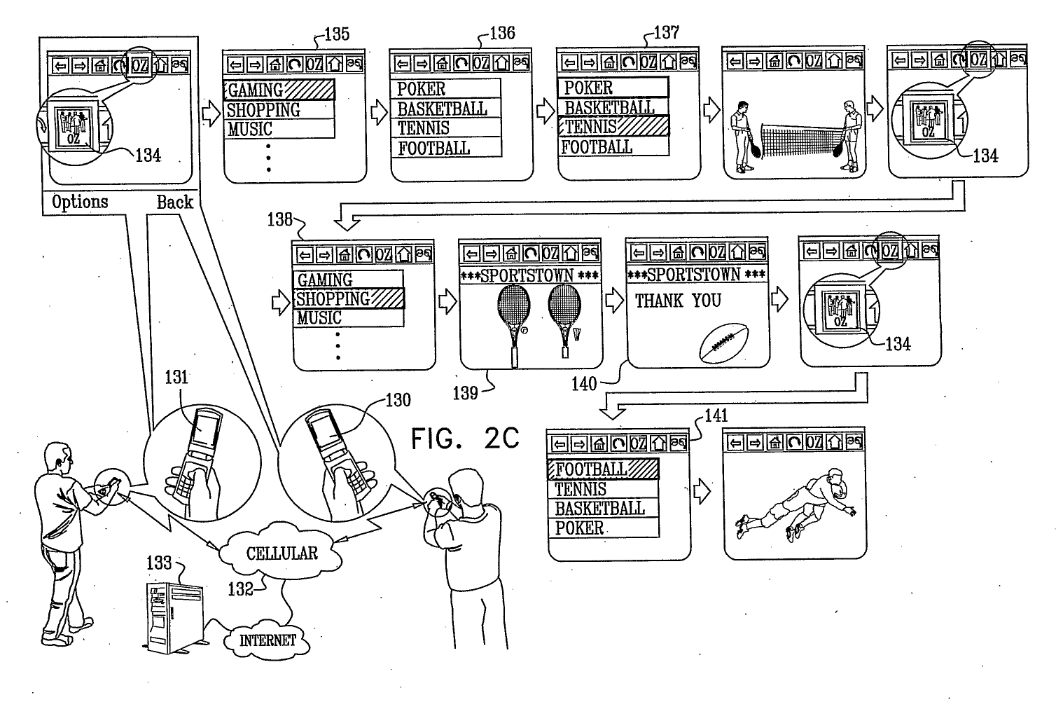

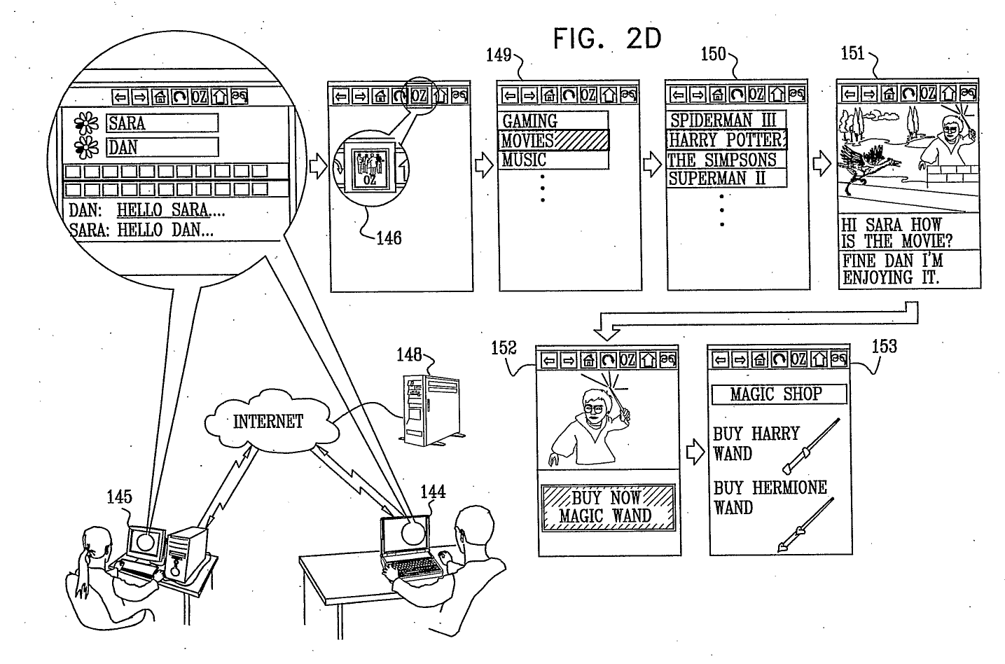

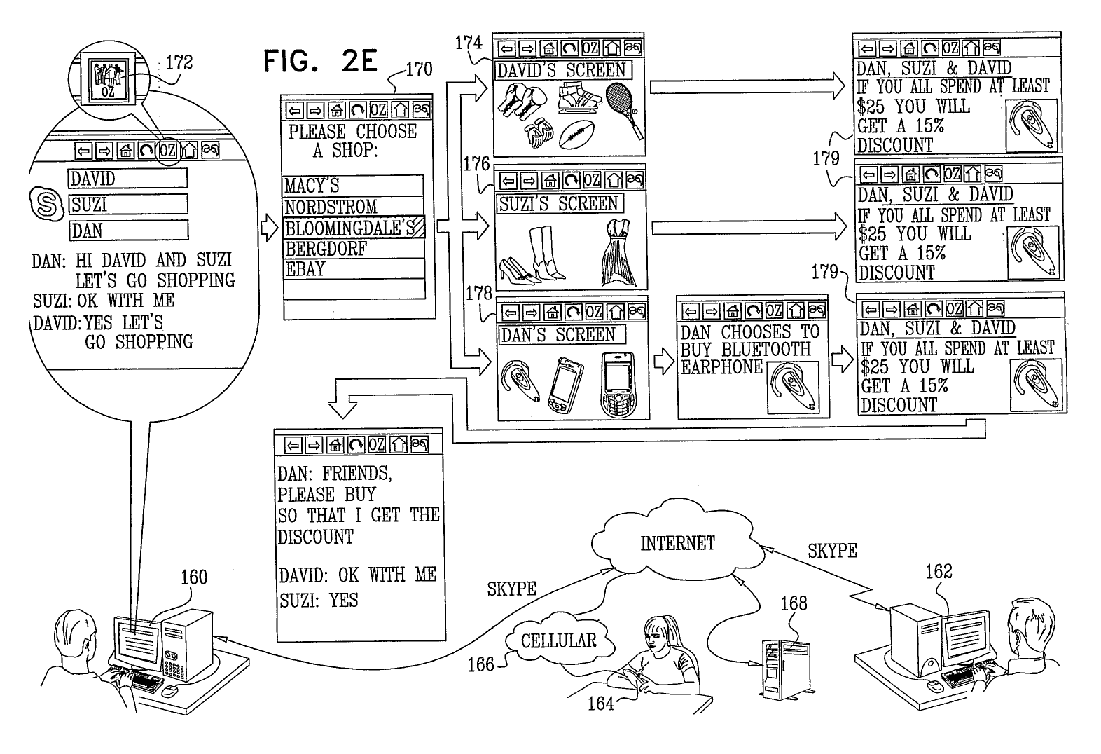

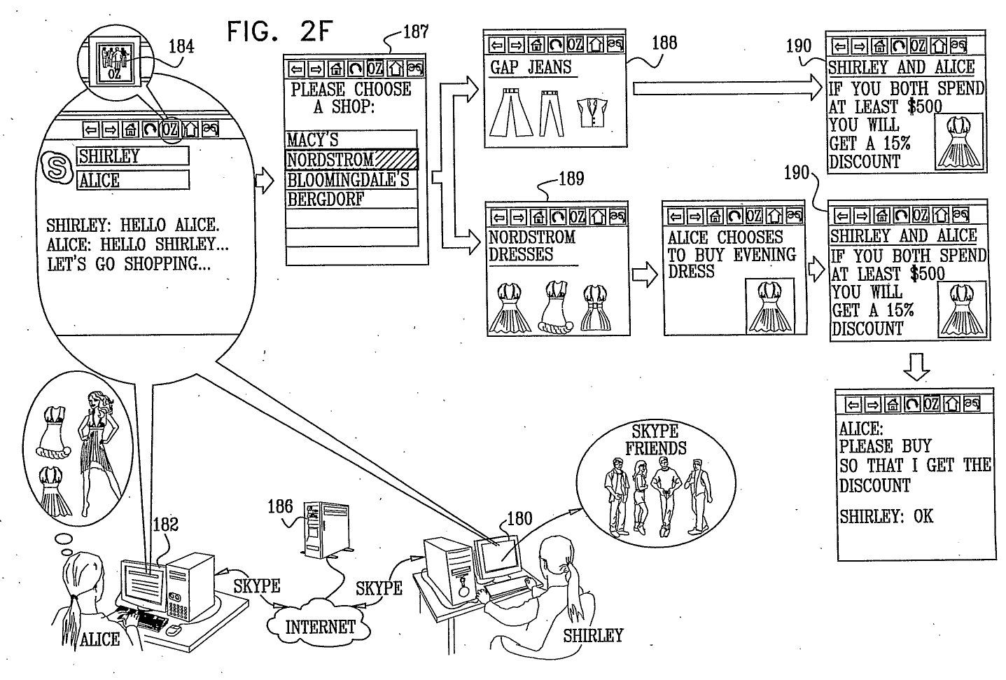

Reference is now made to FIG. 2A, which is a simplified pictorial illustration of the operation of a networked computer methodology for providing a shared user shopping experience in accordance with a preferred embodiment of the present invention. As seen in FIG. 2A, a wife, using her cell phone 102, sends an SMS message to her husband at work, via his cell phone 104, requesting his help in purchasing a microwave oven. The wife actuates a group activities icon 106 on her cell phone 102, here termed an OZ icon, and elects to go shopping together with her husband at the Stanford Mall via the Internet. The networked computer methodology employs a cellular network 108, communicating via the Internet with a shopping server 109, here dedicated to the Stanford Mall, and with a mutually interactive Internet activities server 110 typically associated with the cellular network 108, which, in this case, shows a group activities selection screen 112 followed by a mall selection screen 114.

The welcome display at the Stanford Mall, indicated at reference numeral 115, is responsive to known information about the husband and the wife, gleaned from various commercially available sources, such as, for example, their credit history, shopping history, browsing history, employment history and personal profiles available on the Internet, such as by means of a GOOGLE® search. The welcome display, in the illustrated embodiment, greets the husband and the wife by name and congratulates them on the recent birth of their first grandchild.

Although at least the husband thought that he was shopping for a microwave oven, the welcome display, indicated at reference numeral 116, immediately leads the husband and the wife to BABY GAP® and to a display of clothes for newborns. When it comes to paying, the relevant web page initially displays the credit card information of the husband, rather than that of the wife, indicated at reference numeral 117.

It is appreciated that in the illustrated embodiment of FIG. 2A, information regarding at least one of the users in the group, here information about the recent birth of their grandchild, indicating at least one common characteristic of the group of users, is used for configuring at least part of the common shared Internet activity experience responsive to the at least one common characteristic. In this case, their shopping is initially directed to baby clothes. It is appreciated that had the husband or the wife been Internet shopping alone, the system would not have necessarily acted in the same way based on the same information regarding one of them, since it appreciated that the purchase of clothes for a baby is particularly appropriate for a group shopping experience of grandparents.

Reference is now made to FIG. 2B, which is a simplified pictorial illustration of the operation of a networked computer methodology for providing a shared user shopping experience in accordance with another preferred embodiment of the present invention. As seen in FIG. 2B, a father and a son are collaborating on math problems in the context of an Internet whiteboard via their desktop computers 120 and 121. In the course of their collaboration, they decide to take a break. The son actuates a group activities icon 122, here termed an OZ icon, on his computer 121, and elects to go shopping together with his father via the Internet. The networked computer methodology employs a group activities center 123 communicating via the Internet with computers 120 and 121 and with multiple store dedicated shopping servers, including a server 124, here dedicated to RADIO SHACK®. Group activities center 123, in this case, shows a group activities selection screen 125 followed by a welcome and store selection screen 126, a calculator offer screen 127 and a transaction screen 128.

The welcome and store selection screen 126 at the Shopping Is Us Internet Mall is responsive to known information about the father and the son, gleaned from various commercially available sources, such as, for example, their credit history, shopping history, browsing history including history of recent whiteboard activities which indicates, inter alia, subjects and skill levels. The welcome display, in the illustrated embodiment, greets the father and son by name and initially leads them to RADIO SHACK® and to a display of calculators suitable for the skill level of the son.

Although at least the son thought that he might be shopping for a bicycle, the system, based on the father and son's most recent collaborative Internet activity, lead them elsewhere, as seen in calculator offer screen 127. When it comes to paying, as seen in transaction screen 128, the relevant web page initially displays the credit card information of the father, rather than that of the son, even though the purchase is for the son.

It is appreciated that in the illustrated embodiment of FIG. 2B, information regarding at least one of the users in the group, here information that the father and the son were working on math problems at a certain level, indicating at least one common characteristic of the group of users, is used for configuring at least part of the common shared Internet activity experience responsive to the at least one common characteristic. In this case, their shopping is initially directed to calculators. It is appreciated that had either the father or the son been Internet shopping alone, the system would not have necessarily acted in the same way based on the same information regarding one of them, since it appreciated that the purchase of a calculator is particularly appropriate for a group shopping experience of the father and son immediately following a joint interactive math experience.

Reference is now made to FIG. 2C, which illustrates a further scenario, wherein two friends are conversing on their respective cell phones 130 and 131 and agree to engage in an Internet group activity together. The networked computer methodology employs a cellular network 132, communicating via the Internet with a mutually interactive Internet activities center 133 not typically associated with the cellular network 132.

Both of the friends actuate a group activities icon 134, here termed an OZ icon, on their respective cell phones 130 and 131, and view a group activity selection screen 135 and elect to play games on the Internet. Based on the known profiles of the friends, a groupized menu of games 136 is presented to the pair of friends. They elect to play on-line tennis, as indicated at reference numeral 137. Once they finish their game, they decide to explore other Internet group activities and one of them again actuates the group activities icon 134 and elects Internet group shopping as indicated by reference numeral 138.

It is appreciated that upon the actuation of group activities icon 134 on both cell phones 130 and 131, both cell phones 130 and 131 are shown at least partially identical screens during their group activity session. It is appreciated that more than two cell phones may be included in the group.

Based on the fact that they just played Internet tennis at a relatively high skill level, they are introduced directly to SPORTSTOWN and are shown a display of high end tennis rackets and presented with a group offer to buy a pair of tennis rackets at a reduced price, as indicated at reference numeral 139. It is appreciated that based on the outcome of the Internet tennis game, each of the friends may receive a customized message, such as “NOW THAT YOU WON ON THE INTERNET, HOW ABOUT WINNING ON THE COURT WITH OUR BEST TENNIS RECQUETS?”

The friends each purchased football equipment, as indicated by reference numeral 140, rather than tennis gear and again actuated the group activities icon 134 and again elected on-line games. Based, inter alia, on the recent purchases by both members of the group, they are presented with a menu headed by on-line football games, as indicated by reference numeral 141.

Reference is now made to FIG. 2D, which illustrates a further scenario wherein a teenage couple are conversing on their respective computers 144 and 145 via an instant messaging program. The boy invites the girl to participate in a group activity by actuating a group activities icon 146, here termed an OZ icon, on his computer 144, and they elect to see a movie together. The networked computer methodology employs a group entertainment server 148 communicating via the Internet with computers 144 and 145. Group entertainment server 148 in this case shows a group entertainment selection screen 149 followed by a movie screen 150 and a movie merchandising offer screen 151.

Based on the known ages of the couple, a groupized menu of movies is presented to the couple, as seen in movie screen 150. They elect to see HARRY POTTER®. Each one of the couple sees the movie on his and her computer in synchronism and they are able to converse both orally and textually during their viewing of the movie, as seen in offer screen 151. At appropriate times during the movie, advertisements which are groupized to match, inter alia, their profiles and current Internet activities, are shown. One such advertisement is for HARRY POTTER® merchandise, as seen in screen indicated by reference numeral 152. The boy clicks on the advertisement link and the movie is paused and both the boy and the girl enter an Internet store offering his and her HARRY POTTER® merchandise, as seen in screen indicated by reference numeral 153, at a group discount appropriate for the couple. The couple may return to the movie at will. If they did not buy HARRY POTTER® merchandise, subsequent advertisements will not feature such merchandise.

Reference is now made to FIG. 2E, which illustrates a further scenario wherein three teenagers are conversing via SKYPE® two of them on their respective computers 160 and 162 and one via her cell phone 164. The networked computer methodology employs a cellular network 166, communicating via the Internet with a shopping server 168, here dedicated to the Stanford Mall, which, in this case, shows a shop selection screen 170.

The three teenagers agree to go shopping together and one actuates a group activities icon 158, here termed an OZ icon, on his computer 160, and elects shopping.

Based, inter alia, on the known ages, genders and interests of the three teenagers, a groupized offering of stores is automatically presented to them. They elect to enter BLOOMINGDALE'S®. Each one of the group of three teenagers may see the same or different products at any given time, as illustrated for example by screens 174, 176 and 178. When one member of the group selects a product for purchase, offers 179 appear on the screens of all three teenagers offering a discount on that product and/or other products bought during the shopping trip by members of the group. The member who initially selected the product and stands to obtain a discount if his friends also purchase something, sends a message to his friends urging them to buy so that he will get the discount.

Reference is now made to FIG. 2F which illustrates another scenario wherein two teenage girls, Shirley and Alice, are conversing via SKYPE® on their respective computers 180 and 182. They agree to go shopping together and Shirley actuates a group activities icon 184, here termed an OZ icon, on her computer 180, and elects shopping. The networked computer methodology employs a host, here a shopping server 186, here dedicated to the Stanford Mall, which, in this case, shows a shop selection screen 187, followed by separate shopping screens 188 and 189 for each of Alice and Shirley and common offer screens 190 which are shown simultaneously to Shirley and Alice.

The system initially has some information about Alice but no information about Shirley. However, Shirley does have a list of friends on SKYPE® and/or on FACEBOOK® and information is known about some of those friends. The system generates information about Shirley based, inter alia, on known information about her SKYPE® and/or FACEBOOK® friends and known information about Alice.

The information about Alice indicates that she likes frilly dresses. Based on an analysis of the information about the SKYPE® and/or FACEBOOK® friends of Shirley, the system concludes that she probably prefers designer jeans. Each of the girls is initially directed to a different store, according to their perceived preferences, however they still enjoy a groupized shopping experience at multiple levels, in that their common age and gender are taken into account in what products are offered to them, they are enabled to communicate with each other via the system while shopping and they are offered discounts based on their group shopping activity, for example, when one member of the group selects a product for purchase, an offer appears on the screens of the other offering a discount on that product and/or other products bought during the shopping trip by both of them, notwithstanding that they are shopping in different stores.

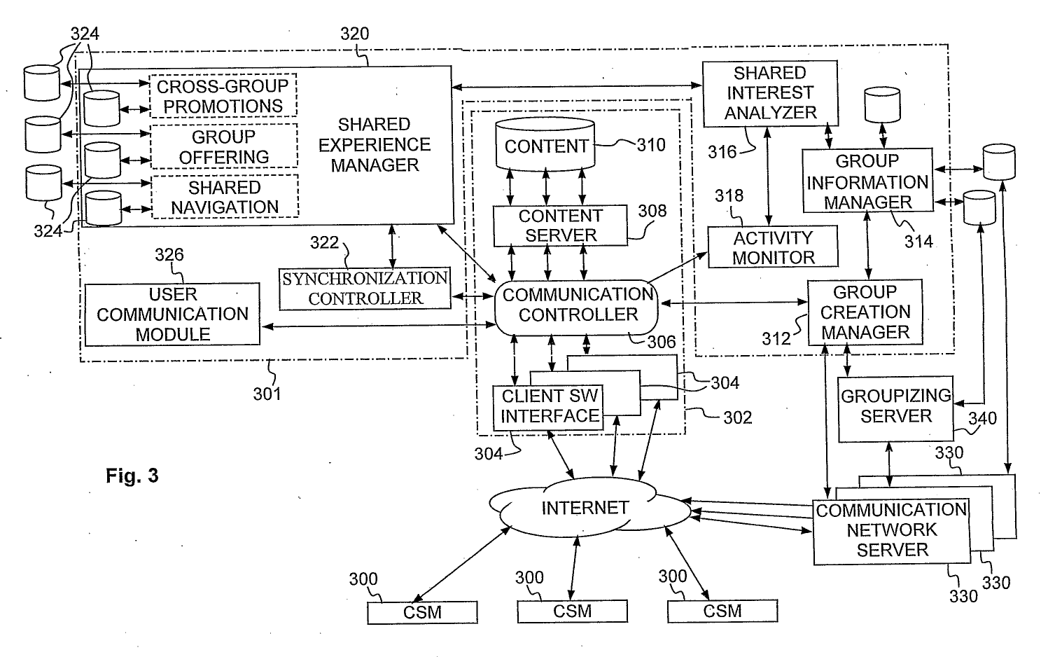

Reference is now made to FIG. 3, which is a simplified block diagram illustration of a system and functionality for providing a groupized Internet group experience in accordance with a preferred embodiment of the present invention which provides, inter alia, functionalities, examples of which appear in FIGS. 1-2F.

As seen in FIG. 3, a plurality or multiplicity of client software modules 300, providing for example, web browsing, instant messaging, VOIP, multimedia communications, video communications and text messaging, which may be embodied in any suitable hardware, such as a desktop computer, a laptop computer, a PDA and a cellular telephone employed by a user, are coupled to the Internet by any suitable communications interface, for example, a cellular telephone network, a computer communications network and via the Internet to one or more hosts 301, including, inter alia, web server assemblies 302. The client software modules 300 may be implemented in conventional Internet browsers such as MICROSOFT® EXPLORER® and FIREFOX®. Hosts 301 and web server assemblies 302 provide groupized Internet group experience functionality in accordance with a preferred embodiment of the present invention.

Each such web server assembly 302 preferably comprises a plurality or multiplicity of client software interfaces 304, corresponding in number to the number of clients that can be simultaneously served by the web server assembly. The client software interfaces 304, such as browser drivers, communicate via a communications controller 306 with a content server 308, which in turn communicates with a dedicated content database 310. It is appreciated that communications controller 306 need not be a discrete element but may have its functionality incorporated in another element, such as client software interfaces 304 or content server 308.

Groupizing functionality is preferably provided by group creation manager 312 which interfaces with a group information manager 314 having access to one or more group information databases. The group information manager 314 communicates with a shared interest analyzer 316, which in turn communicates with an activity monitor 318 and with a shared experience manager 320. The shared experience manager 320 communicates with a synchronization controller 322 and preferably provides multiple shared experience functionalities, for example cross-group promotions, group offers and shared navigation and may employ internal or external databases 324, which may be dedicated for each such functionality, as illustrated. A user communications module 326 preferably provides communication between users in the course of the shared experience. All or most of the elements described hereinabove may communicate with each other via the communications controller 306.

Communications controller 306 preferably provides group creation manager 312, activity monitor 318, shared experience manager 320, synchronization controller 322 and user communication 326 access to client software interfaces 304 and the communication between the client software interfaces 304 and the content server 308.

Communication controller 306 provides the interface with group creation manager 312 to enable individual users of web server assembly 302 to form a group. Communication controller 306 also enables activity monitor 318 to monitor users activities related to web pages presented by content server 308. Communication controller 306 further interfaces with shared experience manager 320 to present customized web pages, pop-up windows and/or Internet information via selected client software interfaces 304. Communication controller 306 also enables synchronization controller 322, upon request from shared experience manager 320, to synchronize the display of selected web pages, pop-up windows and Internet information via selected client software interfaces 304. Communication controller 306 additionally enables user communication module 326 to display inter-personal communication windows via selected client software interfaces 304.

Servers 330 of various communication networks, such as a cellular network server, a SKYPE® server, an ICQ® server, and a WINDOWS LIVE MESSENGER® server preferably communicate directly with the group information 314 and may also communicate directly with the group creation manager 312.

One or more external groupizing servers 340 may provide communication between various servers 330 and various web server assemblies 302. Groupizing servers 340 preferably include functionality of the group creation manager 312 and the group information manager 314. These functionalities may be replicated in the various client software modules 300, hosts 301 and servers 330 so as to provide group activity functionality at client software modules 300, hosts 301 and servers 330 independently of the functioning of the groupizing servers 340 or in cooperation therewith.

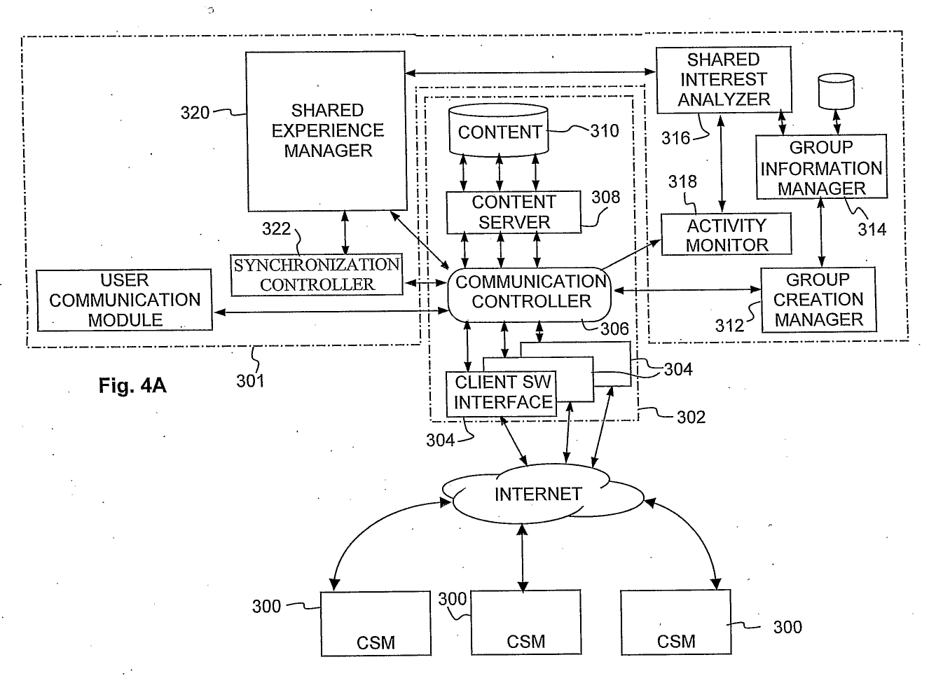

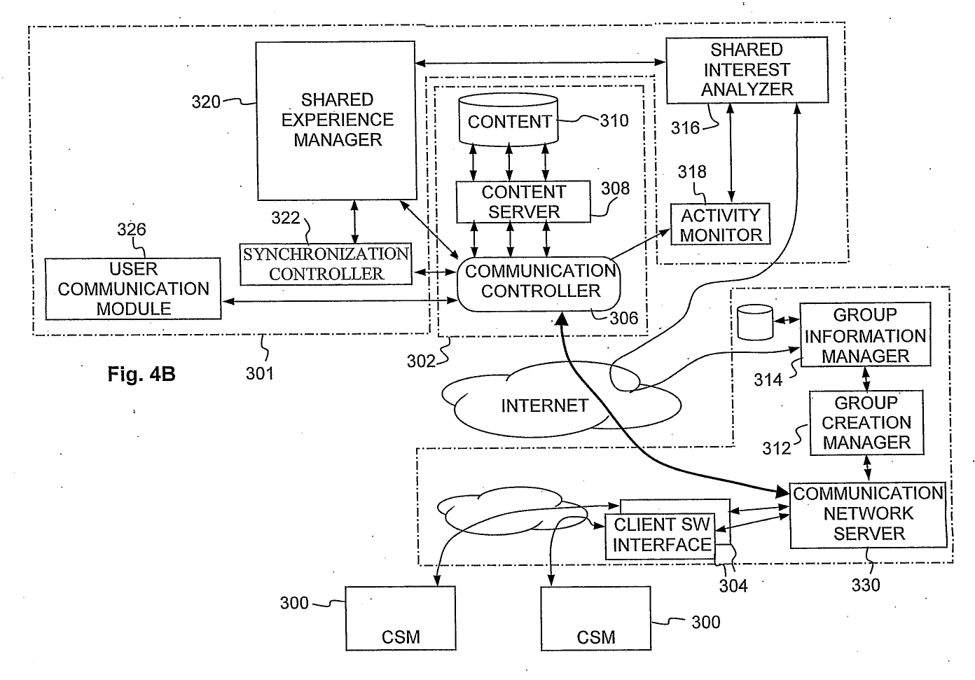

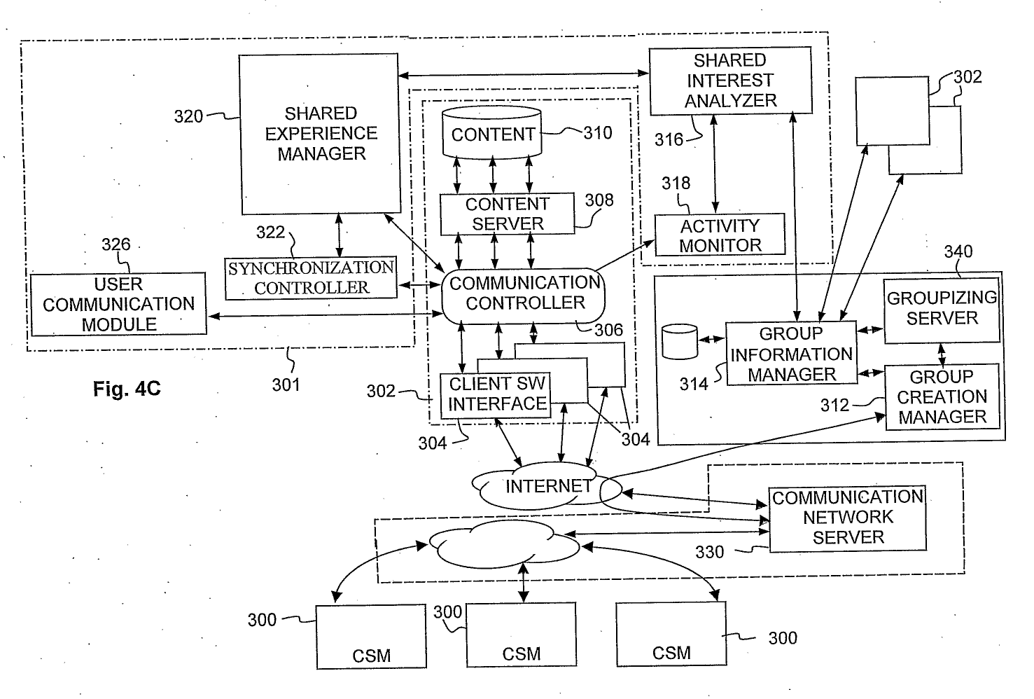

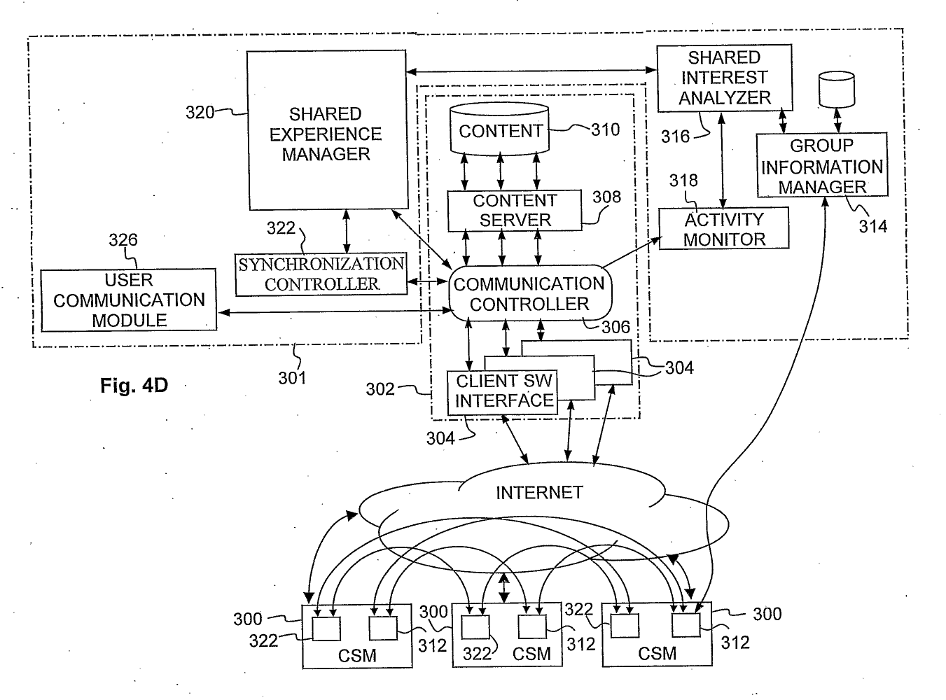

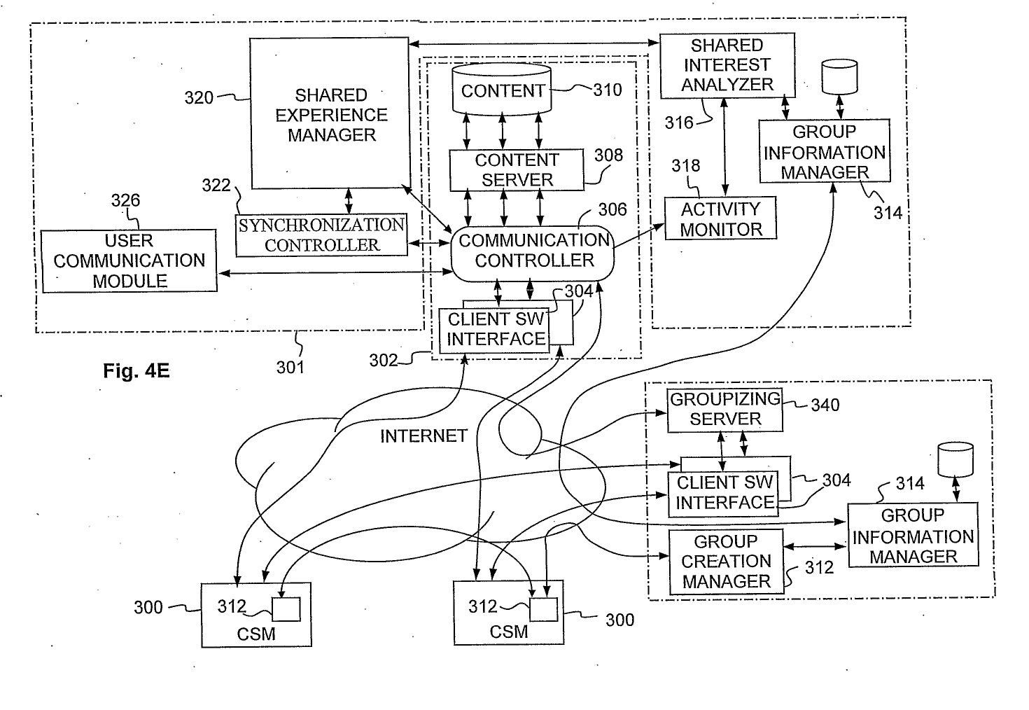

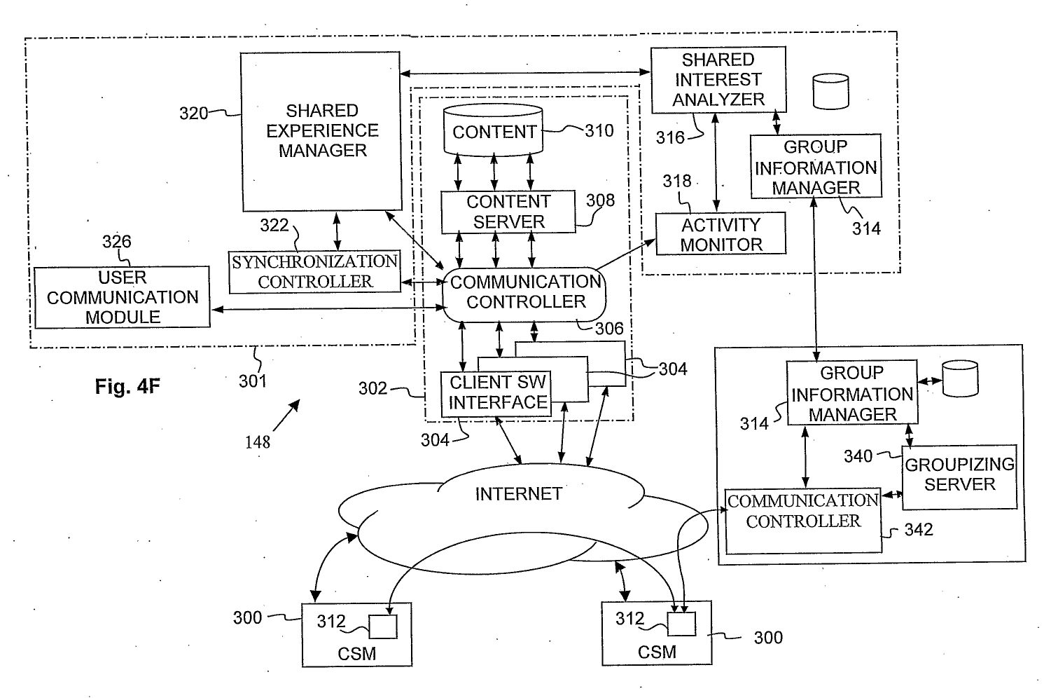

Reference is now made to FIG. 4A, which illustrates in simplified form one configuration of the system architecture of FIG. 3. As seen in FIG. 4A, the group creation manager 312 is dedicated to a web server assembly 302.

Reference is now made to FIG. 4B, which illustrates in simplified form another configuration of the system architecture of FIG. 3. As seen in FIG. 4B, the group creation manager 312 is associated with a server 330 of a communications network and communicates with the shared interest analyzer 316 of the host 301 via group information manager 314.

Reference is now made to FIG. 4C, which illustrates in simplified form yet another configuration of the system architecture of FIG. 3. As seen in FIG. 4C, the group creation manager 312 is associated with a server 330 of a communications network and communicates via groupizing server 340.

Reference is now made to FIG. 4D, which illustrates in simplified form still another configuration of the system architecture of FIG. 3. As seen in FIG. 4D, the group creation manager 312 and the synchronization controller 322 both reside in a client software module 300.

Reference is now made to FIG. 4E, which illustrates in simplified form yet a further configuration of the system architecture of FIG. 3. As seen in FIG. 4E, the group creation managers 312 reside in client software modules 300. Group creation managers 312 communicate with group creation manager 312 associated with groupizing server 340, with which client software modules 300 communicate via client software interfaces 304.

Reference is now made to FIG. 4F, which illustrates in simplified form a further another configuration of the system architecture of FIG. 3. As seen in FIG. 4F, the group creation manager 312 resides in a client software module 300 and communicates via groupizing server 340 and a communication controller 342.

Returning now to FIGS. 2A-2F, with reference to FIGS. 4A-4F, the operation of the system of FIGS. 1-4F will now be briefly described by tracing the functionality thereof through the structure shown in FIGS. 4A-4F.

Reference is now made again to FIG. 2A, wherein a wife using her cell phone 102, sends an SMS message to her husband at work, via his cell phone 104, requesting his help in purchasing a microwave oven, and to FIG. 4B. The wife actuates a group activities icon 106 on her cell phone 102, thereby actuating group activities initiation functionality of client software module 300 in her cell phone 102.

Client software module 300 communicates with group creation manager 312 of server 310 via a communication network server 330 which forms part of the cellular communications network 108. Server 330 presents to at least the wife group activities selection screen 112 followed by mall selection screen 114. The wife elects to go shopping together with her husband at the Stanford Mall via the Internet.

In accordance with a preferred embodiment of the present invention, group creation manager 312 receives an indication, from client software module 300 of cell phone 102, that cell phone 102 has just received an SMS message from cell phone 104 and therefore group creation manager automatically includes cell phone 102 and cell phone 104 in the group being created. Alternatively, group creation manager 312 may be operative to send a “Do you want to join group being formed?” inquiry to cell phone 104 and wait for a positive response before forming the group.

In accordance with another preferred embodiment of the present invention group creation manager 312 may also include functionality to allow the user of cell phone 102 to select potential group members from a list of contacts, each of whom is then contacted and asked to join the group. Group creation manager 312 may also be operative, at any time during the group activity to allow additional group members to be invited to join using any suitable invitation method.

It is appreciated that any type of suitable communication method may be utilized in the formation of a group, such as voice, text, video, messaging, multimedia and Internet collaboration.

The welcome display 115 at the Stanford Mall, responsive to known information about the husband and the wife, gleaned from various commercially available sources, such as, for example, their credit history, shopping history, browsing history, employment history, and personal profiles available on the Internet, such as by means of a GOOGLE® search or a FACEBOOK® profile, is generated by the following functionality:

Actuation of the group activities icon 106 on cell phone 102, causes group creation manager 312 to form a group data structure based, inter alia, on personal data structures of the husband and the wife provided by the group information manager 314 employing databases forming part of the cellular network 108. The group information manager 314 receives the group data structure from the group creation manager 312 and communicates the group data structure and personal data structures of the members of the group to shared interest analyzer 316 of the Stanford Mall server 109.

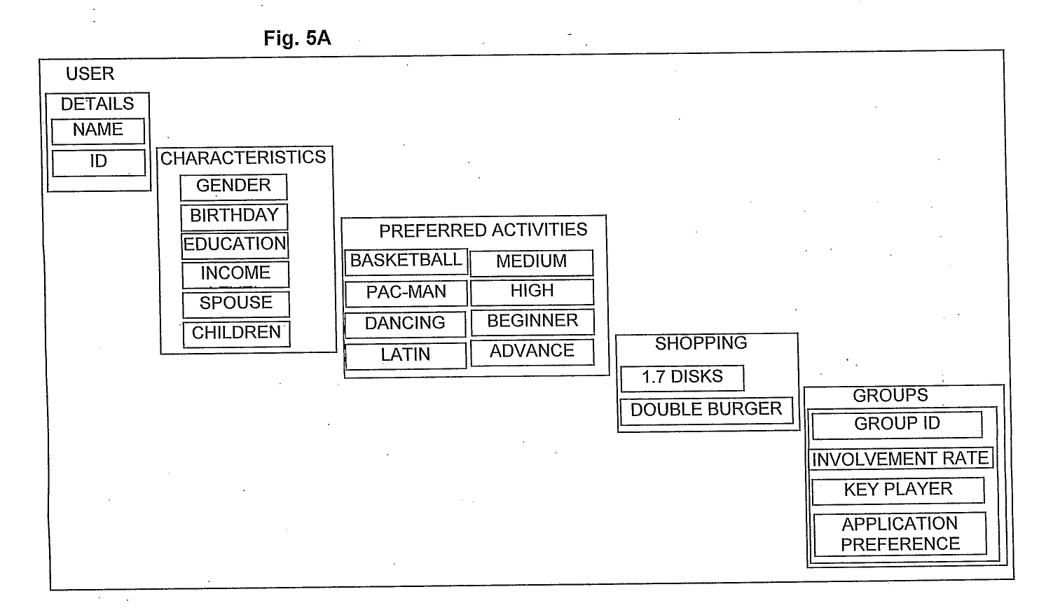

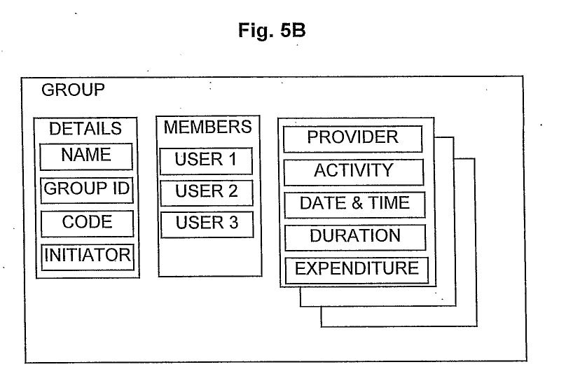

Reference is now made to FIG. 5A, which illustrates a personal data structure administered by group information manager 314. The personal data structure preferably includes a user name and ID, and user profiles including: characteristics, such as gender, birthday, income, spouse, children, past activities, education levels and skill levels at various activities; preferences, such as basketball, pac-man, dancing, latin; shopping history, browsing history and past Internet group activities, including group ID, activity, group member IDs and expenditures.

Reference is now made to FIG. 5B, which illustrates a group data structure administered by group information manager 314. The group data structure preferably includes a group ID, a session code and an identification of the user who initiated the creation of the group. User IDs of all of the members of the group may serve to provide a link to their personal profiles including profiles built upon associations with other groups. Group activities records may include particulars of the activity, date and time, duration and expenditure incurred. In the illustrated embodiment of FIG. 2A, the personal and group profiles and the group activities records may be employed to provide information indicating the recent birth of a grandchild.

Returning to FIG. 4B, the shared interest analyzer 316 examines the information contained in the group data structure and decides to prioritize the recent birth of a grandchild to the members of the group.

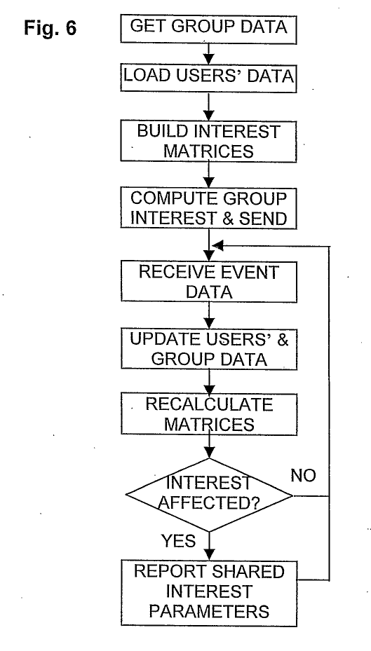

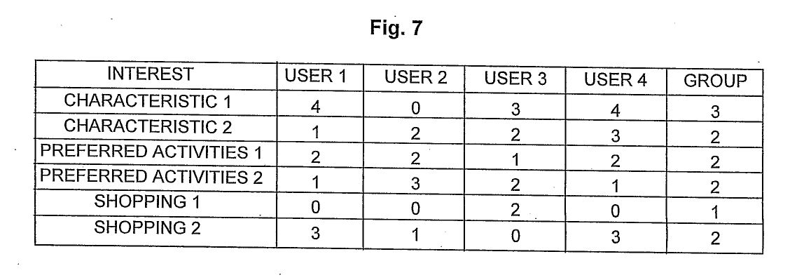

Reference is now made to FIG. 6, which is a simplified illustration of functionality of shared interest analyzer 316. The shared interest analyzer 316 obtains the contents of the group data structure and the personal data structures of the members of the group and builds, based thereon, shared interest matrix, an example of which appears in FIG. 7.

Turning to FIG. 7, it is seen that a shared interest matrix preferably includes scores of each of the parameters in the personal data structure, such as that in FIG. 5A, for each of the users in the group. The shared interest analyzer 316 employs the shared interest matrix to calculate shared interest parameters for the group using appropriate weighting and transmits the shared interest parameters to shared experience manager 320, preferably along with individual parameters of each of the members of the group.

Returning to FIG. 6, it is a particular feature of the present invention that the shared interest matrix is updated and the shared interest parameters are recalculated, preferably in real time, by the shared interest analyzer 316, based on information received from the activity monitor 318 and based on changes in the contents of the group and/or personal data structures. Examples of events which result in shared interest matrix updates are the addition of a new group member, the exiting of the group by a group member, purchase of a product by a member of the group, a death in the family of a member of the group, results of a search on GOOGLE® by one or more members of the group, a change in a FACEBOOK® event or profile of a friend of one of the group members or the birth of a child or grandchild to a member of the group. The shared interest analyzer 316 concurrently updates the contents of the group data structures and the personal data structures administered by the group information manager 314.

Returning to FIGS. 2A and 4B, it is appreciated that the shared experience manager 320, based on the shared interest parameters received from the shared interest analyzer 316, selects one or more shared experience options to be presented to one or more of the members of the group. In the present case, screen 116, directing the husband and the wife to baby clothes at the GAP®, is generated by the shared experience manager 320.

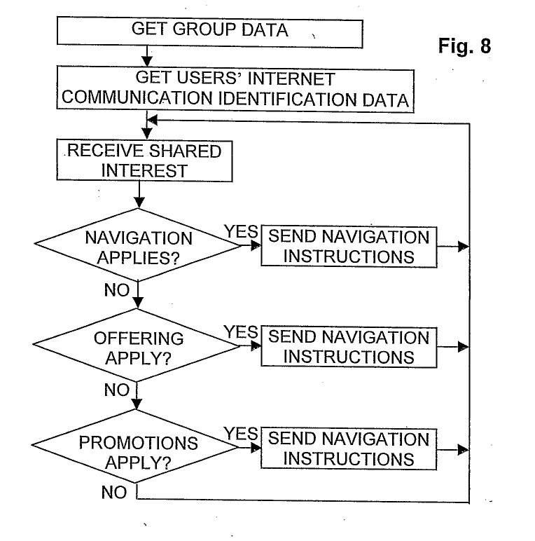

Reference is now made to FIG. 8, which illustrates the operation of the shared experience manager 320. As seen in FIG. 8, the shared experience manager 320 obtains from the shared interest analyzer 316, Internet communication identification data for all of the members of the group as well as the shared interest parameters. Depending on the particular fact situation, the shared experience manager 320 sends one or more of cross-group promotions, group offerings and shared navigation content to one or more of the members of the group. In the present example of FIG. 2A, the shared experience manager 320 causes screen 116 to appear on the telephones 102 and 104 of the husband and the wife.

If the husband or the wife decided to make a purchase of baby clothes, the group and personal profiles of the husband and the wife may be updated in real time, causing the shared interest matrix to be correspondingly updated and resulting in updated shared interest parameters being sent to the shared experience manager 320. As part of the purchase transaction functionality, the shared experience manager 320 may be responsive to the updated information, or may act independently of such an update, to display screen 117 requesting the credit card number of the husband rather than of the wife for this particular purchase.

Reference is now made again to FIG. 2B, wherein a father and a son are collaborating on math problems in the context of an Internet whiteboard and in the course of their collaboration, they decide to take a break, and to FIG. 4E. The son actuates group activities icon 122, here termed an OZ icon, on his computer 121, and elects to go shopping together with his father via the Internet.

Client software modules 300 which reside on desktop computers 120 and 121 are preferably peer-to-peer software modules and each include a group creation manager 312. Group creation managers 312 communicate via the Internet with each other in order to create a group, in this case, consisting of the father and son employing computers 120 and 121. The group creation managers 312 also communicate with an independent group activities center 123, here called “SHOPPING IS US”. Group activities center 123 includes client software interfaces 304, group creation manager 312, group information manager 314 and groupizing server 340.

Groupizing server 340 and client software modules 300 cooperate to present to the members of the group, group activities selection screen 125 followed by store selection screen 126. The father and son elect to go shopping together at RADIO SHACK® via the Internet.

The calculator offer screen 127 at RADIO SHACK®, responsive to known information about the father and the son, gleaned from various commercially available sources, such as, for example, their cooperative work on the white board and the level of skill evidenced in that cooperative work, their credit history, shopping history, browsing history, employment history, and personal profiles available on the Internet, such as by means of a GOOGLE® search and/or FACEBOOK® profiles, is generated by the following functionality:

Actuation of the group activities icon 122, causes group creation managers 312 to form a group and together with groupizing server 340 to create a data structure based, inter alia, on personal data structures of the father and the son provided by the group information manager 314 employing databases forming part of the group activities center 123. The group information manager 314 receives the group data structure including the information contained therein from the groupizing server 340 and communicates the group data structure including the information contained and personal data structures of the members of the group to shared interest analyzer 316 of RADIO SHACK® server 124.

The personal data structure shown generally in FIG. 5A and described hereinabove, preferably includes information about the skill level of the son in mathematics.

The group data structure shown generally in FIG. 5B also preferably takes into account the skill level of the son in mathematics and also the skill level of the father.

Returning to FIG. 4E, the shared interest analyzer 316 examines the information contained in the group data structure and decides to prioritize the recent whiteboard activity of the members of the group. The functionality of FIGS. 6 and 7 operates generally as described hereinabove.

Returning to FIGS. 2B and 4E, it is appreciated that the shared experience manager 320, based on the shared interest parameters received from the shared interest analyzer 316, selects one or more shared experience options to be presented to one or more of the members of the group. In the present case, screen 127, directing the father and the son to calculators at RADIO SHACK® is generated by the shared experience manager 320. It is appreciated that had the group been composed of two teenagers having had the same whiteboard experience, the shared experience manager might have directed them to other products, based on economic or other considerations.

The functionality of FIG. 8 operates generally as described hereinabove. In the present example of FIG. 2B, the shared experience manager 320 causes screen 127 to appear on computers 120 and 121 of the father and son.

If the father and the son decide to make a purchase of a calculator, the group and personal profiles of the father and the son may be updated in real time, causing the shared interest matrix to be correspondingly updated and resulting in updated shared interest parameters being sent to the shared experience manager 320. As part of the purchase transaction functionality, the shared experience manager 320 may be responsive to the updated information or may act independently of such an update to display screen 128 requesting the credit card number of the father rather than of the son for this particular purchase.

Reference is now made again to FIG. 2C, wherein two teenagers are together engaged in Internet group activities of various types, and to FIG. 4C. Both teenagers actuate group activities icons 134, here tuned OZ icons, on their respective telephones 130 and 131 and one or both elect gaming together on the Internet.

Client software modules 300, which reside on telephones 130 and 131, communicate with group creation manager 312 of group activity center 133 via a communication network server 330 which forms part of the cellular communications network 132. Group creation manager 312 creates a group, in this case, consisting of the two teenagers employing cellular telephones 130 and 131. Group activities center 133 also includes group information manager 314 and groupizing server 340.

Groupizing server 340 and client software module 300 cooperate to present to the members of the group, group activities selection screen 135 followed by a game selection screen 136.

The game selection screen 136 is responsive to known information about the two teenagers, gleaned from various commercially available sources, such as, for example, their level of skill in various Internet games as evidenced by past joint gaming history, as well as the gaming histories of their friends, such as those who appear in an Internet and/or FACEBOOK® contact list, who are not in the current group and is generated by the following functionality:

Actuation of the group activities icon 134 causes group creation manager 312 to form a group and together with groupizing server 340 to create a data structure based, inter alia, on personal data structures of the two teenagers provided by the group information manager 314 employing databases forming part of the group activities center 133. The group information manager 314 receives the group data structure from the groupizing server 340 and communicates the group data structure and personal data structures of the members of the group to shared interest analyzer 316 of one or more relevant servers which may include, for example, gaming servers, shopping servers and video servers.

The personal data structure shown generally in FIG. 5A and described hereinabove, preferably includes information about the skill level of both members of the group in tennis.

The group data structure shown generally in FIG. 5B also preferably takes into account the skill levels of the members of the group in tennis.

Returning to FIG. 4C, the shared interest analyzer 316 of a shopping server examines the information contained in the group data structure and decides to prioritize the recent Internet tennis activity of the members of the group. The functionality of FIGS. 6 and 7 operates generally as described hereinabove.

Returning to FIGS. 2C and 4C, it is appreciated that the shared experience manager 320, based on the shared interest parameters received from the shared interest analyzer 316, selects one or more shared experience options to be presented to one or more of the members of the group. In the present case, screen 139, directing the members of the group to tennis rackets, is generated by the shared experience manager 320. It is appreciated that had the group been composed of two teenagers, only one of whom had ever played Internet tennis at a high level, the shared experience manager might have directed them to other products, based on economic or other considerations.

The functionality of FIG. 8 operates generally as described hereinabove. In the present example of FIG. 2B, the shared experience manager 320 causes screens 139 and 141 to appear on cellular telephones 130 and 131 of the two teenagers.

Reference is now made again to FIG. 2D, wherein a girl and a boy are communicating using instant messaging, and to FIG. 4F. The boy actuates group activities icon 146, here termed an OZ icon, on his computer 144, and invites the girl to see a movie together with him via the Internet.

Client software modules 300 which reside on desktop computers 144 and 145 are preferably peer-to-peer software modules and each includes a group creation manager 312. Group creation managers 312 communicate via the Internet with each other in order to create a group, in this case, consisting of the boy and the girl employing computers 144 and 145. The group creation managers 312 also communicate with a group entertainment server 148. Group activities server 148 includes group information manager 314, groupizing server 340 and communication controller 342.

Groupizing server 340 and client software modules 300 cooperate to present to the members of the group, group activities selection screen 149 followed by movie selection screen 150.

The group activities screen 149 and the movie selection screen 150 are responsive to known information about the girl and the boy, gleaned from various commercially available sources, such as, for example, their instant messaging communications and are generated by the following functionality:

Actuation of the group activities icon 146, causes group creation managers 312 to form a group and, together with groupizing server 340, to create a data structure based, inter alia, on personal data structures of the girl and the boy provided by the group information manager 314 employing databases forming part of the group entertainment server 148. The group information manager 314 receives the group data structure from the groupizing server 340 and communicates the group data structure and personal data structures of the members of the group to shared interest analyzer 316 of the group entertainment server 148.

The personal data structure shown generally in FIG. 5A and described hereinabove, preferably includes information about the interests of the boy and girl as evidenced by their instant messaging communications, FACEBOOK® information and browsing history.

The group data structure shown generally in FIG. 5B also preferably takes into account the interests of the boy and girl as evidenced by their instant messaging communications and browsing history.

Returning to FIG. 4F, the shared interest analyzer 316 examines the information contained in the group data structure and decides to prioritize the recent communications between the boy and the girl about movies in general and fantasy in particular. The functionality of FIGS. 6 and 7 operates generally as described hereinabove.

Returning to FIGS. 2D and 4F, it is appreciated that the shared experience manager 320, based on the shared interest parameters received from the shared interest analyzer 316, selects one or more shared experience options to be presented to one or more of the members of the group. In the present case, screens 152 and 153, offering toy HARRY POTTER® and Hermione wands to the boy and the girl precisely following a scene in which HARRY POTTER® is shown waving his wand, is an example of this functionality.

The functionality of FIG. 8 operates generally as described hereinabove. In the present example of FIG. 2D, the shared experience manager 320 causes screen 152 to appear on computers 144 and 145 of the boy and girl.

Reference is now made again to FIG. 2E, wherein three teenagers communicating via SKYPE® and a cellular network agree to go shopping together, and to FIG. 4D. One of the three actuates group activities icon 172, here termed an OZ icon, on his computer 160, and elects to go shopping together with his friends via the Internet.

Client software modules 300 which reside on desktop computers 160 and 162 and on cellular telephone 164 are preferably peer-to-peer software modules and each include a group creation manager 312 and a synchronization controller 322. Group creation managers 312 communicate via the Internet with each other in order to create a group, in this case, consisting of the three friends employing computers 160 and 162 and cellular telephone 164. The group creation managers 312 also communicate with host 301, here a shopping server 168 dedicated to the Stanford Mall. Shopping server 168 includes group information manager 314 which cooperates with activity monitor 318 and shared interest analyzer 316.

Group information manager 314 and software modules 300 cooperate to presents to the members of the group, store selection screen 170. In this scenario, each of the three friends sees a different screen, as illustrated for example by screens 174, 176 and 178 in FIG. 2E. When one member of the group selects a product for purchase, offers 179 simultaneously appear on the screens of all three teenagers offering a discount on that product and/or other products bought during the shopping trip by members of the group. Synchronization of the display of the offer 179 which appears on the screens of the three teenagers is preferably provided by synchronization controllers 322. Synchronization controllers receive display information regarding the offer from the shared experience manager 320 and ensure that it appears simultaneously on the screens of computers 160 and 162 and cellular telephone 164.

The member who initially selected the product and stands to obtain a discount if his friends also purchase something, sends a message to his friends urging them to buy so that he will get the discount.

Reference is now made again to FIG. 2F, wherein two teenagers communicating via SKYPE® agree to go shopping together, and to FIG. 4A. Shirley actuates a group activities icon 184, here termed an OZ icon, on her computer 180, and elects to go shopping together with Alice via the Internet.

Client software modules 300 which reside on desktop computers 180 and 182 communicate with a group creation manager 312 residing on a host 301, here a shopping server 186 dedicated to the Stanford Mall. Shopping server 186 includes a group creation manager 312 which cooperates with a group information manager 314 and a shared interest analyzer 316.

Group creation manager 312 cooperates with group information manager 314 to present to the members of the group, store selection screen 187. In this scenario, each of the friends sees a different screen belonging to a different store, as illustrated for example by screens 188 and 189 in FIG. 2F. When one member of the group selects a product for purchase, offers 190 simultaneously appear on the screens of both teenagers offering a discount on that product and/or other products bought during the shopping trip by members of the group. Synchronization of the display of the offer 190 which appears on the screens of computers 180 and 182 is preferably provided by synchronization controller 322. Synchronization controller 322 receives display information regarding the offer from the shared experience manager 320 and ensures that it appears simultaneously on the screens of computers 180 and 182.

The group member, who initially selected the product and stands to obtain a discount if her friend also purchases something, sends a message to her friend urging her to buy so that she will get the discount.

It will be appreciated by persons skilled in the art that the present invention is not limited to what has been specifically described hereinabove. Rather, the present invention includes combinations and subcombinations of various features described hereinabove as well as modifications and variations thereof which would occur to persons skilled in the art upon reading the foregoing description and which are not in the prior art.

1. (canceled)

2. A method for mutually interactive Internet activities according to claim 88 and also comprising:
sensing the existence of communications between said plurality of users; and
in response to a group actuation input from at least one of said plurality of users, defining said group of users including said plurality of users based upon said sensing of the existence of communications.

3. A method for mutually interactive Internet activities according to claim 88 and also comprising enabling at least some of said plurality of users in said group of users to communicate during said at least partially common shared Internet activity experience.

4. (canceled)

5. A method for mutually interactive Internet activities according to claim 88 and wherein said information regarding at least one of said users is updated based on user activity during said at least partially common shared Internet activity experience and said updated information is employed in reconfiguring at least part of said at least partially common shared Internet activity experience.

6-8. (canceled)

9. A method for creating virtual groups of persons in an Internet environment comprising:
sensing the existence of communications between at least two persons;
in response to a group actuation input from at least one of said at least two persons, defining a virtual group including said at least two persons based upon said sensing of the existence of communications; and
communicating information regarding the virtual group to an Internet activity server for enabling said Internet activity server to provide at least partially common shared Internet activity experience to members of said virtual group.

10. A method for creating virtual groups of persons in an Internet environment according to claim 9 and wherein said information regarding the virtual group includes at least one characteristic characterizing said virtual group.

11. A method for creating virtual groups of persons in an Internet environment according to claim 9 and wherein said information includes identification of members of said virtual group.

12. A method for creating virtual groups of persons in an Internet environment according to claim 9 and wherein said information includes Internet addressing information of members of said virtual group.

13-18. (canceled)

19. A method for creating virtual groups of persons in an Internet environment comprising:
receiving information regarding a virtual group at an Internet activity server for enabling said Internet activity server to provide at least partially common shared Internet activity experience to members of said virtual group, wherein said information regarding the virtual group includes at least one characteristic characterizing said virtual group.

20. A method for creating virtual groups of persons in an Internet environment according to claim 19 and wherein said information includes identification of members of said virtual group.

21. A method for creating virtual groups of persons in an Internet environment according to claim 19 and wherein said information includes Internet addressing information of members of said virtual group.

22. A method for creating virtual groups of persons according to claim 19 and also comprising enabling at least some of said persons in said group to communicate during said at least partially common shared Internet activity experience.

23-28. (canceled)

29. A method for interactive Internet activities according to claim 88 and wherein said content comprises a commercial offer.

30. A method for interactive Internet activities according to claim 88 and also comprising:
based on said content, configuring an at least partially common shared Internet activity experience for said group of users; and
enabling at least some of said users in said group of users to communicate during said at least partially common shared Internet activity experience.

31. A method for mutually interactive Internet activities according to claim 30 and also comprising synchronizing the display of said at least partially common shared Internet activity experience to said group of users.

32-37. (canceled)

38. A method for interactive Internet activities according to claim 88 and also comprising:
based on said content, configuring an at least partially common shared Internet activity experience for said group of users; and
enabling at least some of said users in said group of users to communicate during said at least partially common shared Internet activity experience.

39. (canceled)

40. A method for mutually interactive Internet activities according to claim 38 and wherein said information regarding at least one of said users is updated based on user activity during said at least partially common shared Internet activity experience and said updated information is employed in reconfiguring at least part of said at least partially common shared Internet activity experience.

41-52. (canceled)

53. A system for creating virtual groups of persons in an Internet environment comprising:
a communications sensor operative to sense the existence of communications between at least two persons;
a virtual group definer operative in response to a group actuation input from at least one of said at least two persons to define a virtual group including said at least two persons based upon said sensing of the existence of communications; and
a communicator operative to communicate information regarding the virtual group to an Internet activity server for enabling said Internet activity server to provide at least partially common shared Internet activity experience to members of said virtual group.

54-62. (canceled)

63. A system for creating virtual groups of persons in an Internet environment comprising:
a group creation manager operative to define a virtual group comprising a plurality of users and represented by a plurality of user clients; and
an Internet activity server receiving information regarding said virtual group for providing an at least partially common shared Internet activity experience to members of said virtual group, wherein said information regarding the virtual group includes at least one characteristic characterizing said virtual group.

64-87. (canceled)

88. A method for interactive Internet activities comprising:
connecting a plurality of user clients, which together represent a group of users, to at least one Internet activity server; and
supplying to each of said plurality of user clients representing said group of users content from said at least one Internet activity server wherein said content is selected from a group consisting of
at least partially identical content, whereby each of said plurality of users in said group of users has at least partially common, shared Internet activity experience; and based on information regarding at least one of said users in said group of users, which information indicates at least one common characteristic of said plurality of users in said group of users, configuring said at least partially common shared Internet activity experience responsive to said at least one common characteristic; and
content based at least in part on Internet activity experience of at least one of:
at least another one of said group of users; and
a person known to be associated with at least one of said group of users.

89. A system for providing interactive Internet activities comprising:
at least one of:
a shared interest analyzer operative, based on information regarding at least one of a plurality of users in a group of users, which information indicates at least one common characteristic of said plurality of users in said group of users, defining at least one shared interest of said plurality of users in said group of users; and
a group creation manager operative to define a virtual group comprising a plurality of users and represented by a plurality of user clients; and
a shared experience manager operative to perform at least one of:
supply to each of a plurality of user clients representing said group of users, at least partially identical content from at least one Internet activity server, whereby each of a plurality of users in said group of users has at least partially common shared Internet activity experience, based at least partially on said at least one shared interest; and
supply to at least one of said plurality of user clients representing one of said group of users, content from at least one Internet activity server based at least in part on Internet activity experience of at least one of:
at least another one of said group of users; and
a person known to be associated with at least one of said group of users.
